(19) United States
(12) Patent Application Publication
(10) Pub. No.: US 2013/0335197 A1
(43) Pub. Date: Dec. 19, 2013

(54) Electronic system comprising of a plurality of electronic equipment units, electronic equipment for such a system and method for management and maintenance of such a system

(71) Applicant: THALES, Neuilly Sur Seine (FR)

(72) Inventors: Engin ODER, Toulouse (FR); Francine PIERRE, Meudon La Foret (FR); Alain Claude Guy BIBAUT, Meudon La Foret (FR)

(21) Appl. No.: 13/919,394

(22) Filed: Jun. 17, 2013

(30) Foreign Application Priority Data
Jun. 15, 2012 (FR) 12 01712

(51) Int. Cl. G06K 7/00

(52) U.S. Cl. CPC G06K 7/0008
USPC 340/10.1

(57) ABSTRACT

The electronic system includes of a plurality of electronic equipment and devices (6) and a network for communication (8) between equipment units, each equipment unit (6) having the ability to be integrated into the electronic system or removed from the electronic system, each equipment unit (6) being provided with a radio tag (20) having an electronic circuit (22) containing a memory (24) capable of storing data in electronic form, including identification data for the equipment unit (6) and a radio antenna (26) for exchanging data with the electronic circuit (22). Each equipment unit (6) includes an internal communication device (32) integrated into the equipment unit (6) and configured in order to communicate with the radio tag (20). The system is applicable in particular to electronic systems for aircraft, railway vehicles, motor vehicles, boats, medical facilities, etc.

The present invention relates to the field of electronic systems comprising of a plurality of electronic equipments units, each equipment unit to be integrated into the electronic system or removed from the electronic system.

The present invention relates in particular to an electronic system mounted on board in a vehicle, in particular an aircraft such as an airplane or a helicopter.

An electronic system fitted on board an aircraft typically comprises of a plurality of electronic equipments units incorporating integrated testing devices configured so as to generate maintenance reports relating to the operation of the equipment, for example in order to indicate a failure or fault, and a centralised maintenance system connected to the equipment units in order to centralise operation reports generated by the integrated testing devices.

Each equipment has unit a configuration corresponding to the type to which the electronic equipment belongs, to the serial number of the equipment unit and the versions of software and/or hardware components of the equipment unit. The configuration of the equipment unit may change over time such as for instance, following a change in a software component of the equipment.

It is necessary to monitor the configuration of an equipment unit, in particular in order to verify and ensure the compatibility between the equipment units integrated into the electronic system.

The maintenance teams are responsible for maintaining the electronic system in operation based in particular on messages originating from the integrated testing devices of the equipment for the purposes of constructing failure and fault diagnostics, identifying and/or locating the failures and, if necessary, repairing or replacing a faulty equipment unit.

Knowing the configuration of an equipment unit enables a maintenance crew to replace a faulty equipment unit with a new equipment unit having either the same configuration or a configuration that is different but appropriate for integration into the electronic system.

For management of the configuration and management of the maintenance of equipment units, it is possible to provide each equipment unit with an internal memory for storage of its configuration and maintenance data related to the equipment unit.

Access to data related to configuration and maintenance stored in the internal memory of each equipment is possible by way of the centralised maintenance system.

However, these data are only accessible when the equipment unit is supplied with power and connected to a communication network.

It is possible to provide each equipment unit with a radio frequency identification tag or radio tag, commonly referred to as RFID tag or chip the expression corresponding to the acronym for “Radio Frequency Identification”. A radio tag includes an electronic circuit incorporating a memory allowing for storing data and a radio antenna enabling exchange of data with the electronic circuit through radio communication.

For management of the configuration and management of the maintenance, the configuration and maintenance data related to an electronic equipment unit are stored in the memory of the radio tag of this electronic equipment unit, which makes it possible to access these by using a radio tag reader, without the equipment unit itself needing to be supplied with electrical energy.

Document WO2008/065084 discloses a device for configuration management and maintenance management of an electronic system using a radio tag provided on each equipment unit for the storage of configuration related data and maintenance related data for this equipment unit.

One of the goals of the invention is to provide an electronic system comprising of a plurality of electronic equipment units that enables the maintenance of equipment and the management of configuration in a manner that is effective and easy to implement.

To this end, the invention provides an electronic system comprising of a plurality of electronic equipment and devices and a network for communication between equipment units, each equipment unit being connected to the communication network through an interface, each equipment unit having the ability to be integrated into the electronic system or removed from the electronic system, each equipment unit being provided with a radio tag having an electronic circuit containing a memory capable of storing data in electronic form, including identification data for the equipment unit and a radio antenna for exchanging data with the electronic circuit, characterised in that each equipment unit includes an internal communication device integrated into the equipment unit and configured in order to communicate with the radio tag.

According to other embodiments, the system includes one or more of the following characteristic features, taken individually or in accordance with any technically possible combinations:
a centralised maintenance system connected to the communication network in order to exchange data with each equipment unit;
a portable or hand held maintenance terminal that is configured to exchange data with the centralised maintenance system, the maintenance terminal comprising a radio transmitter receiver for exchanging data with the radio tag of each equipment unit;
each radio tag is configured so as to enable reading from and writing to the memory of the radio tag by means of the maintenance terminal;
each radio tag is configured so as to enable reading from and writing to the memory of the radio tag by means of the internal communication device;
the internal communication device of at least one equipment unit includes a communication cable for enabling a wired connection;
the internal communication device of at least one equipment unit is configured so as to establish a wireless link;
the internal communication device of at least one equipment unit comprises an in built internal radio transmitter-receiver integrated into the equipment unit for exchanging data with the radio tag;
the radio tag of at least one equipment unit comprises an antenna for exchanging data with a transmitter-receiver external to the equipment and for exchanging data with the internal radio transmitter-receiver, or an external communication antenna dedicated to the exchange of data with a transmitter-receiver external to the equipment unit and an internal communication antenna that is different from the external communication antenna and is dedicated to the exchange of data with the internal radio transmitter-receiver; and
each equipment unit comprises an integrated testing device, the internal communication device being configured or configurable so as to enable writing to the radio tag data originating from the integrated test device.

The invention also relates to an electronic equipment unit of an electronic system as defined above.

The invention further relates to a method for management of an electronic system comprising of a plurality of electronic equipment units and a wired communication network, each equipment unit being connected to the communication network by a detachable connector, each equipment unit may be integrated into the electronic system or removed out of the electronic system, each equipment unit being provided with a radio tag having an electronic circuit containing a memory capable of storing data in electronic form, including identification data for the equipment unit and a radio antenna for exchanging data with the electronic circuit, and wherein data related to identification, configuration and/or maintenance can be to read from and/or written to the memory of the radio tag of at least one equipment unit by means of a built in internal communication device integrated into this equipment unit and configured in order to exchange data with the radio tag.

According to one implementation, the data related to identification, configuration and/or maintenance are read from and/or written to the memory of the radio tag of at least one equipment unit by means of using a hand held maintenance terminal via radio communication between the maintenance terminal and the radio tag.

According to one implemented embodiment, data are read from and/or written to the radio tag by means of a communication cable of the internal communication device or of a radio transmitter-receiver of the internal communication device configured to exchange data with an antenna of the radio tag dedicated to communication with the internal communication device or provided in addition to enable communication with a transmitter-receiver that is external to the equipment unit. The invention and its advantages shall be better understood upon reading the description which follows, given solely by way of example with reference being made to the accompanying drawings, in which:

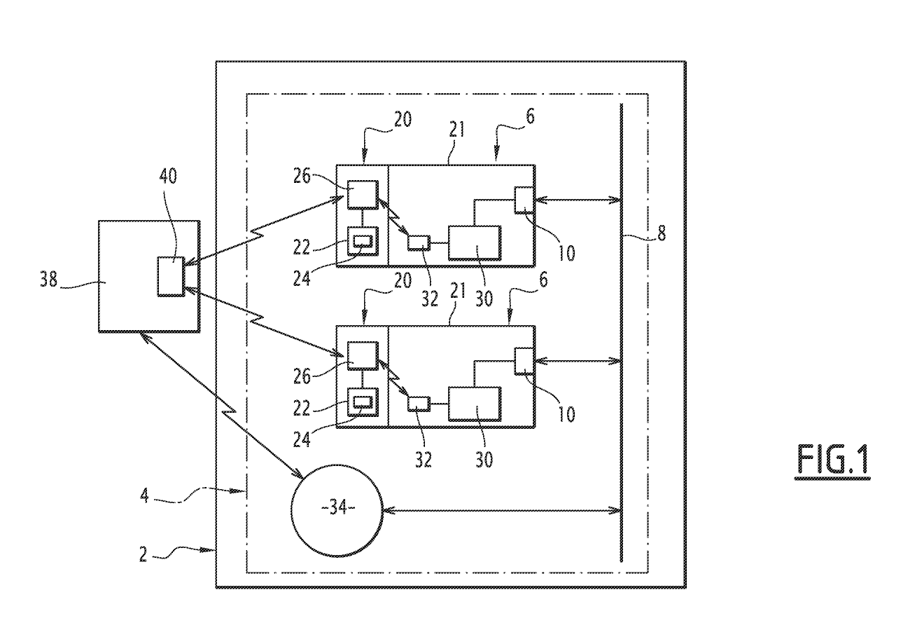

FIG. 1 schematically represents an aircraft comprising an electronic system according to the invention; and

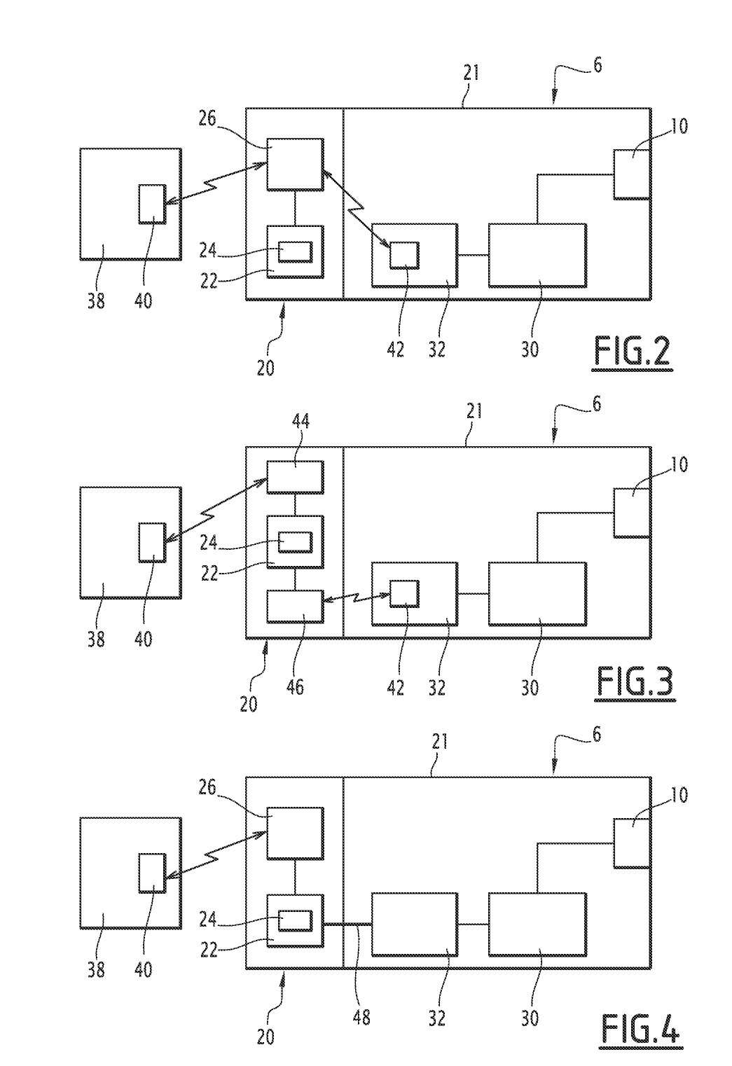

FIGS. 2 to 4 represent the electronic equipment and devices of the system in FIG. 1 according to the variant embodiments.

FIG. 1 illustrates an aircraft 2 having a complex electronic system 4 comprising of a plurality of electronic equipment units 6 and a network for communication 8 between the equipment and devices.

The communication network 8 enables the electronic equipment units 6 to exchange data amongst themselves. The communication network 8 is generally referred to as “internal communication bus” of the aircraft.

Each equipment unit 6 is connected to the communication network 8 in a detachable manner such that each equipment unit 6 can be integrated into the electronic system 4 by being connected to the communication network 8, or taken out of the electronic system, by being disconnected from the communication network 8.

Each electronic equipment unit 6 includes a connection interface to the communication network 8.

The communication network 8 is based either on a wired link, and in this case comprises of electrical cables for data exchange and/or fibre optic data exchange lines, or on a wireless link, for example via radio waves.

In the example illustrated, the communication network 8 is wired. Each electronic equipment unit 6 includes a connection interface in the form of a connector 10 for connecting the electronic equipment unit 6 to the communication network 8.

In the case of a wireless link communication network, each electronic equipment unit includes an interface connection capable of transmitting and receiving data through communication via radio waves.

Each electronic equipment unit 6 constitutes a replaceable unit referred to as a “Line Replaceable Unit” also known by the English acronym LRU.

Each electronic equipment unit 6 is provided with a radio frequency identification RFID tag or radio tag 20. The radio tag 20 is integrally attached to the electronic equipment unit, for example in a housing 21 thereof.

Each radio tag 20 includes an electronic circuit 22 incorporating a non-volatile memory 24 for storing data in electronic form, and an antenna 26 for communication by radio waves, connected to the electronic circuit 22 in order to allow data exchange with the electronic circuit 22.

The electronic circuit 22 is configured so as to enable reading from and writing to the memory 24.

The radio tag 20 is capable of receiving the energy necessary for its operation by means of the antenna 26 and of exchanging data by means of the antenna 26, so as to enable reading from and writing to the memory 24 of the radio tag 20 by using a transmitter-receiver external to the electronic equipment unit 6.

The radio tag 20 is passive: it is configured to be supplied with the electrical energy required for its operation by means of its antenna 26.

Each electronic equipment unit 6 includes an in built test device 30 which is integrated into the electronic equipment unit 6. The expression “Built-In Test Equipment” is used to refer to such an integrated test device which is hence also designated by the corresponding acronym BITE.

The integrated test device 30 is configured so as to control the operation of the electronic equipment unit 6 and to generate error messages or maintenance reports relating to the operation of the electronic equipment unit 6.

Each electronic equipment unit 6 includes an internal communication device 32 integrated into the electronic equipment unit 6 in order to allow data exchange between the electronic equipment unit 6 and the radio tag 20 of the electronic equipment unit.

The internal communication device 32 is formed exclusively by internal components of the electronic equipment unit 6.

The internal communication device 32 enables an exchange of data between the integrated test device 30 and the radio tag 20.

The radio tag 20 is configured so as to enable reading from and writing to the memory 24 of the radio tag 20 by the integrated test device 30.

The electronic system 4 includes a centralised maintenance system 34 connected to communication network 8 in order to communicate with each electronic equipment unit 6 and in particular with each integrated test device 30.

The centralised maintenance system 34 is configured to be able to send testing instructions and commands to each integrated test device 30 in order to carry out a test on the electronic equipment unit 6, to receive test reports sent from each integrated test device 30, and to send to each electronic equipment unit 6 instructions for reading from and/or writing to the memory of the radio tag of this electronic equipment unit 6.

The centralised maintenance system 34 is configured so as to retrieve configuration related data from each electronic equipment unit 6 by means of the communication network 8.

The electronic system includes a portable or hand held maintenance terminal 38 that is configured to communicate with the centralised maintenance system 34 and with each radio tag 20.

The maintenance terminal 38 is configured to be able to exchange data with the centralised maintenance system 34, via a wired link and/or a wireless link of any suitable type, such as a radio link or a WiFi connection.

The maintenance terminal 38 is configured so as to retrieve configuration related data and operation related data related to each electronic equipment unit 6 by means of the centralised maintenance system 34.

The maintenance terminal 38 is configured so as to send instructions to the centralised maintenance system 34, in particular instructions associated with each electronic equipment unit 6, in particular instructions for reading and/or writing data from/to the memory 24 of the radio tag 20 of the electronic equipment unit 6.

The maintenance terminal 38 is configured so as to exchange data directly with the radio tag 20 of each electronic equipment unit 6 by radio communication with the radio tag 20 by means of an antenna 26 of the radio tag 20.

The maintenance terminal 38 includes for this purpose a radio transmitter-receiver for the terminal 40 configured to exchange data with the radio tag 20.

The radio tag 20 of each electronic equipment unit 6 is configured so as to enable reading from and writing to the memory 24 of the radio tag 20 by the radio transmitter-receiver of the terminal 40.

The maintenance terminal 38 can thus read from and write to the memory 24 of the radio tag 20 of each electronic equipment unit 6 when the power of the electronic equipment unit 6 is turned on or when it is turned off.

Various different internal communication devices are illustrated in FIGS. 2 to 4.

As illustrated in FIG. 2, the internal communication device 32 of each electronic equipment unit 6 establishes a radio frequency wireless link with the electronic tag 20.

The internal communication device 32 comprises an internal radio transmitter-receiver 42 configured to exchange data with the radio tag 20 via radio communication with the antenna 26 of the radio tag 20.

The radio tag 20 comprises the antenna 26 configured so as to exchange data with the radio transmitter-receiver of the terminal 40 external to the electronic equipment unit 6 and with the internal radio transmitter-receiver 42 within the electronic equipment unit 6.

The data exchanges between the transmitter-receiver of the terminal 40 and the radio tag 20 and the data exchanges between the internal transmitter-receiver 42 and the radio tag 20 use either the same frequency or different frequencies.

The variant in FIG. 3 differs from that in FIG. 2 in that the radio tag 20 includes a dedicated external communication antenna 44 for exchanging data with the transmitter-receiver of the terminal 40 and another dedicated internal communication antenna 46 for exchanging data with the internal transmitter-receiver 42 of the internal communication device 32.

The main frequency for communication between the radio tag 20 and the internal transmitter-receiver 42 is preferably different from that between the radio tag 20 and the transmitter-receiver of the terminal 40.

As shown in FIG. 4, the internal communication device 32 establishes a wired link and includes a communication cable 48. The communication cable 48 here extends between the integrated test device 30 and the radio tag 20.

The communication cable 48 is of any suitable type, such as for example USB, Ethernet, Firewire, etc. The radio tag 20 may be supplied with electric power through the communication cable 48 when the electronic equipment unit 6 has its power turned on while it is also capable of being supplied with electric power by means of its antenna 26 when the electronic equipment unit 6 has its power turned off.

When in operation the radio tag 20 of each electronic equipment unit contains in its memory 24 configuration details of the electronic equipment unit 6, data related to the operation and maintenance of the electronic equipment unit 6.

When electronic equipment unit 6 has its power turned on, in the course of normal operation or during a shutdown phase of the electronic system 4, the integrated test device 30 can read from or write to the memory 24 of the radio tag 6 by means of the internal communication device 32.

Reading from the memory 24 of the radio tag 20 makes it possible to transmit data stored in the radio tag 20 to the centralised maintenance system 34, with the goal of enabling the transmission of a report that may be viewed by means of the maintenance terminal 38.

The ability to write makes it possible to store in the radio tag 20 data related to the tests performed by the integrated test device 20 of the electronic equipment unit 6, the configuration data for the electronic equipment unit 6, the configuration data for the electronic system 4 in its entirety and/or messages sent by the centralised maintenance system 34.

The integrated test device 30 can read from or write to the radio tag 20 based on corresponding instructions sent to the integrated test device 30 by the centralised maintenance system 34 by means of the wired communication network 8.

In one embodiment, the internal communication device 32 and/or the integrated test device 30 are programmed and/or programmable so as to write specific determined data to the radio tag 20.

In order to do this, the integrated test device and/or the internal communication device 32 includes a software component that is programmable by a maintenance operator so as to select the data that will be written to the radio tag 20.

The software component is programmable during maintenance operations carried out on the electronic equipment unit 6 or by means of the centralised maintenance system 34, more specifically by means of the maintenance terminal 38 connected to the centralised maintenance system 34.

During maintenance operations, a maintenance operator can read from or write to the memory 24 of the radio tag 20 by means of the maintenance terminal 38 via radio communication between the maintenance terminal 38 and the radio tag 20. This communication is possible whether the equipment has its power turned on or off.

Thus, the maintenance operator has access to the configuration details of the electronic equipment unit 6 that are stored in the radio tag 20 and to any additional data stored in the radio tag 20.

The operator may also add to the information stored in the radio tag 20. The operator can enter information by making use of the maintenance terminal 38 and thereby write data to the radio tag 20, for example subsequent to a change in configuration of electronic equipment unit 6, following a maintenance operation on the latter, or by transferring information retrieved previously from the centralised maintenance system 34. A change in configuration can result from a change of a hardware component and/or a software component of the electronic equipment.

Advantageously, the radio tag 20 is configured so as to receive and store information and data related to operating conditions of the electronic equipment unit 6. This information and data related to operating conditions, for example, include but are not limited to, information pertaining to the operating temperature to which the electronic equipment unit 6 is exposed, the vibrations transmitted to the electronic equipment unit 6, duration of operation, and in a general manner all relevant information relating to the environment of the electronic equipment unit 6, in particular during the operation of the latter. The information and details related to operating conditions are provided by corresponding sensor devices associated with the electronic equipment unit 6. These sensor devices are for example a temperature sensor to measure the temperature, an accelerometer to measure the vibrations transmitted. This information and details related to operating conditions are received by the electronic equipment unit 6 itself and recorded in the radio tag 20 by means of the internal communication device 32. The information and data related to operating conditions enable the performance of preventive maintenance. Thus, when an electronic equipment unit 6 has endured severe operating conditions that are liable to cause premature aging of one or more components, it is possible to plan for the early replacement of the electronic equipment unit 6 or of components thereof, before the actual onset of a defect in the electronic equipment unit 6 or in a component thereof.

The radio tag 20, in particular when it includes a dedicated internal communication antenna and a dedicated external communication antenna, makes it possible to efficiently retrieve information related to the electronic equipment unit 6, even when the latter is turned off. In fact even when electronic equipment unit 6 has its power turned off, it is possible to interrogate the radio tag 20 at one of a maintenance terminal 38 in order to read therefrom the configuration related information, operation related information recorded by the integrated test device 30 for the purposes of a conventional maintenance activities and/or information related to operating conditions for the purposes of preventative maintenance of the electronic equipment unit 6.

Advantageously, in particular when it includes a dedicated internal communication antenna and a dedicated external communication antenna, the internal communication device 32 and the radio tag 20 of an electronic equipment unit 6 are configured so as to enable an exchange of data upon the electronic equipment unit 6 having its power turned on in a manner so as to ensure the detection and mutual recognition of the internal communication device 32 and the radio tag 20.

In particular in the case of an electronic equipment unit that is replaceable online (or LRU for “Line Replaceable Unit”), such as is used in aircraft, it is possible to configure the electronic equipment unit 6 to enable data exchange upon the electronic equipment unit 6 having its power turned on when the latter is integrated into the electronic system. The mutual recognition of the internal communication device 34 and the radio tag 20 is thus brought about preferably upon the electronic equipment unit 6, having its power turned on, which allows the electronic equipment unit 6 to transmit to the radio tag 20 the energy required for its operation. In one embodiment, upon the power being turned on in the electronic equipment unit 6 the internal communication device 32 and the radio tag 20 exchange a code that enables mutual identification.

As a variant or an alternative option, the internal communication device 32 periodically exchanges data with the associated radio tag 20.

The operation related data provided by the integrated test device 30 and stored in the radio tag 20 allows an operator to directly access these data by reading the radio tags 20 by way of using a maintenance terminal 38, without needing to access a centralised maintenance system 34.

Thanks to the invention, it is possible to effectively manage the configuration and maintenance of a complex electronic system comprising of replaceable electronic equipment units that may be integrated into the electronic system and removed from the electronic system and replaced.

The electronic system makes it possible to enter configuration and maintenance related data in the radio tag or to read the contents of the radio tag even when the electronic system, or at least the electronic equipment unit in question has its power turned off.

The electronic system allows for verifying and ensuring the compatibility of configuration of each electronic equipment unit integrated into the electronic system and the proper functioning of each electronic equipment unit integrated into the electronic system.

The invention is particularly applicable to aircraft, especially to airplanes, wherein the electronic equipment and devices may be replaced, for example during the stopover. It is therefore important to be able to know the compatibility of configuration of a replacement electronic equipment unit with the other electronic equipment units.

The invention is not limited to on board electronic systems of aircraft. The invention is applicable to any electronic system having a plurality of individually replaceable electronic equipment units and subject to maintenance.

Thus, the invention also is applicable to electronic systems for rail vehicles, motor vehicles, boats, medical facilities, etc.

1. An electronic system comprising of a plurality of electronic equipment units (6) and a network for communication (8) between equipment units, each equipment unit (6) being connected to the communication network (8) through an interface (10), each equipment unit (6) having the ability to be integrated into the electronic system or removed from the electronic system, each equipment unit (6) being provided with a radio tag (20) having an electronic circuit (22) containing a memory (24) capable of storing data in electronic form, including identification data for the equipment unit (6) and a radio antenna (26) for exchanging data with the electronic circuit (22), characterised in that each equipment unit (6) includes an internal communication device (32) integrated into the equipment unit (6) and configured in order to communicate with the radio tag (20).

2. An electronic system according to claim 1, comprising of a centralised maintenance system (34) connected to the communication network (8) in order to exchange data with each equipment unit (6).

3. An electronic system according to claim 2, comprising a portable or hand held maintenance terminal (38) that is configured to exchange data with the centralised maintenance system (34), the maintenance terminal (38) comprising a radio transmitter-receiver (40) for exchanging data with the radio tag (20) of each equipment unit (6).

4. A system according to claim 3, wherein each radio tag (20) is configured so as to enable reading from and writing to the memory (24) of the radio tag (20) by means of the maintenance terminal (38).

5. A system according to claim 1, wherein each radio tag (20) is configured so as to enable reading from and writing to the memory of the radio tag (20) by means of the internal communication device (32).

6. An electronic system according to claim 1, wherein the internal communication device (32) of at least one equipment unit (6) includes a communication cable (48) for enabling a wired connection.

7. An electronic system according to claim 1, wherein the internal communication device (32) of at least one equipment unit (6) is configured so as to establish a wireless link.

8. An electronic system according to claim 1, wherein the internal communication device (32) of at least one equipment unit (6) comprises an in built internal radio transmitter-receiver (42) integrated into the equipment unit (6) for exchanging data with the radio tag (20).

9. An electronic system according to claim 8, wherein the radio tag (20) of at least one equipment unit (6) comprises an antenna (26) for exchanging data with a transmitter-receiver (40) external to the equipment (6) and for exchanging data with the internal radio transmitter-receiver (42).

10. An electronic system according to claim 8, wherein the radio tag (20) of at least one equipment unit (6) comprises an external communication antenna (44) dedicated to the exchange of data with a transmitter-receiver (40) external to the equipment unit (6) and an internal communication antenna (46) that is different from the external communication antenna and is dedicated to the exchange of data with the internal radio transmitter-receiver (42).

10. An electronic system according to claim 1, wherein each equipment unit (6) comprises an integrated testing device (30), the internal communication device (32) being configured or configurable so as to enable writing to the radio tag (20) data originating from the integrated test device (30).

11. An electronic system according to claim 1, wherein the internal communication device (32) and the radio tag (20) of at least one electronic equipment unit (6) are configured so as to read from and/or write to the radio tag (20) information and details of conditions of operation related to the operating conditions of the electronic equipment unit.

12. An electronic system according to claim 11, wherein the information and details related to operating conditions include the vibration transmitted to the electronic equipment unit (6), the operating temperature to which the electronic equipment unit (6) is exposed and/or the duration of operation of the electronic equipment unit (6).

13. The electronic equipment of an electronic system according to claim 1.

14. Aircraft having an on board electronic system according to claim 1.

15. A method for management of an electronic system comprising of a plurality of electronic equipment and devices (6) and a wired communication network (28), each equipment unit (6) being connected to the communication network by a detachable connector (10), each equipment unit ((6)) may be integrated into the electronic system or removed out of the electronic system, each equipment unit (6) being provided with a radio tag (20) having an electronic circuit (22) containing a memory (24) capable of storing data in electronic form, including identification data for the equipment unit (6) and a radio antenna (26) for exchanging data with the electronic circuit (22),
wherein data related to identification, configuration and/or maintenance can be to read from and/or written to the memory of the radio tag (20) of at least one equipment unit (6) by means of a built in internal communication device (32) integrated into this equipment unit (6) and configured in order to exchange data with the radio tag (20).

16. A method for management of an electronic system according to claim 15 wherein the data related to identification, configuration and/or maintenance are read from and/or written to the memory of the radio tag (20) of at least one equipment unit (6) by means of using a hand held maintenance terminal (38) via radio communication between the maintenance terminal (38) and the radio tag (20).

17. A method for management of an electronic system according to claim 15 wherein data are read from and/or written to the radio tag (20) by means of a communication cable of the internal communication device (34).

18. A method for management of an electronic system according to claim 15 wherein data are read from and/or written to the radio tag (20) by means of a radio transmitter-receiver of the internal communication device (32) configured to exchange data with an antenna of the radio tag (20) dedicated to communication with the internal communication device (32).

19. A method for management of an electronic system according to claim 15, wherein data are read from and/or written to the radio tag (20) by means of a radio transmitter-receiver of the internal communication device (32) configured to exchange data with an antenna of the radio tag (20) and to enable communication with a transmitter-receiver (40) that is external to the equipment unit (6).

20. A method for management of an electronic system according to claim 15, wherein operation related information and details provided by an integrated test device (30) of the electronic equipment unit (6) are read from and/or written to the radio-tag (20).

21. A method for management of an electronic system according to claim 15 wherein information and details pertaining to operating conditions relating to the operating conditions of the electronic equipment unit are read from and/or written to the radio tag (20).

22. A method for management of an electronic system according to claim 21, wherein the information and details pertaining to operating conditions include the vibrations transmitted to the electronic equipment unit (6), the operating temperature to which the electronic equipment unit (6) is exposed and/or the duration of operation of the electronic equipment (6).

23. A method for management of an electronic system according to claim 21 wherein the information and details pertaining to the operating conditions of an electronic equipment unit (6) are retrieved by means of reading the radio tag (20) of this electronic equipment unit (6) by using a maintenance terminal (38), and subsequently preventative maintenance diagnostics are carried out on the basis of the information read therefrom.
